(19) United States
(12) Patent Application Publication
(10) Pub. No.: US 2019/0139686 A1
(43) Pub. Date: May 9, 2019

(54) METHOD FOR MANUFACTURING RARE-EARTH SINTERED MAGNET

(71) Applicant: STAR GROUP IND. CO., LTD, Daegu (KR)

(72) Inventors: Dong Hwan KIM, Daegu (KR); Young Chul PARK, Daegu (KR); Koon Seung KONG, Daegu (KR)

(21) Appl. No.: 16/098,750

(22) PCT Filed: Jun. 10, 2016
(86) PCT No.: PCT/KR2016/006161

§ 371 Date: Nov. 2, 2018

(30) Foreign Application Priority Data
May 2, 2016 (KR) 10-2016-0054195

(51) Int. Cl. H01F 1/057; B22F 1/00; B22F 3/16; B22F 3/24; C22C 38/00; H01F 41/02

(52) U.S. Cl. CPC H01F 1/0577; B22F 1/0007; B22F 3/16; B22F 3/24; C22C 38/005; C22C 2202/02; H01F 41/0266; B22F 2003/248; B22F 2202/05; B22F 2301/355; H01F 41/0293

(57) ABSTRACT

Provided is a method for manufacturing a rare-earth magnet, the method comprising the steps of preparing a rare-earth magnet powder including R, Fe and B as composition components, wherein, R is at least one element selected from among the rare earth elements including Y and Sc; mixing a heavy rare-earth compound including a heavy rare-earth hydride with the rare-earth magnet powder; molding the powder mixture in a magnetic-field; and sintering and performing heavy rare-earth diffusion at the same time.

### TECHNICAL FIELD

The present invention relates to a method for manufacturing a rare-earth sintered magnet.

### BACKGROUND ART

As the energy saving and eco-friendly green growth projects have been suddenly raised as new issues, active research has been conducted with respect to a hybrid vehicle, which uses in parallel an internal combustion engine using fossil fuel and a motor, or a fuel cell vehicle, which generates electricity by using hydrogen as an eco-friendly energy source as alternative energy and drives a motor by using the generated electricity. Since eco-friendly vehicles have in common the feature of being driven by using electric energy, a permanent magnetic motor and generator are inevitably required. In terms of magnetic materials, the technical demand on a rare-earth sintered magnet having excellent hard magnetic performance has increased to further improve the energy efficiency. Further, in other terms of fuel-efficiency of eco-friendly vehicles besides drive motors, vehicle components, which are used for steering systems, electric parts, etc., need to be light in weight and small in size. For example, to realize a light and small motor, it is necessary to change the multifunctional design of a motor and to replace the permanent magnet material with a rare-earth permanent magnet which has excellent magnetic performance relative to ferrite used previously.

The future production of the aforementioned eco-friendly vehicles is expected to gradually increase on the ground that the policy of regulating carbon emission has been more and more intensified in relation to an increase of oil price caused by an increase of energy use, a solution of health problems caused by environment pollution and a long-term measure of global warming in all areas of the world.

On the other hand, since a permanent magnet used in an eco-friendly vehicle needs to stably maintain its function without losing performance of the magnet in a high temperature environment of 200° C., a high coercivity of 25˜30 kOe is required.

Theoretically, the residual magnetic flux density of a permanent magnet is determined by the conditions: the saturated magnetic flux density of the main phase forming a material, the anisotropic level of crystal grains and the density of the magnet. Since the magnet generates a stronger magnetism to the outside as the residual magnetic flux density increases, the efficiency and performance of equipment are improved in many application fields.

On the other hand, coercivity showing another performance of a permanent magnet has the function to maintain the intrinsic performance of the permanent magnet against environments to demagnetize the magnet, such as, the opposite directional magnetic field, mechanical impacts, etc. Therefore, if the coercivity is more excellent, since environment resistance is good, the magnet with excellent coercivity is usable for high-temperature instruments, large output instruments, etc. Further, since such a magnet can be made thin, the weight of the magnet is reduced to increase economic value.

To manufacture a rare-earth sintered magnet having high coercivity, the light rare-earth element, such as neodymium (Nd) or praseodymium (Pr) of 5˜10 wt %, is designed to be substituted with heavy rare-earth element, such as dysprosium (Dy) or terbium (Tb), in the process of manufacturing an alloy for the magnet. However, the heavy rare-earth element, such as Dy or Tb, is higher by 4˜10 times in price, compared to the light rare-earth element, such as Nd or Pr. Further, the worldwide deposits of heavy rare-earth elements are not abundant and resources are limited. Therefore, to expand the application field of rare-earth magnets and to solve smooth supply and demand issues, a new method is needed for manufacturing the magnet by minimizing the content of a heavy rare-earth element and increasing the coercivity.

From this point of view, the relevant institutes and the rare-earth magnet manufacturing companies from all over the world have sought development to minimize the amount of a heavy rare-earth element used and to improve the coercivity since 2000s. As a representative one of the methods which have been developed, a heavy rare-earth grain boundary diffusion method is presented to minimize the amount of heavy rare-earth elements used, where after a rare-earth sintered magnet is manufactured, a heavy rare-earth element is diffused to the surface of the rare-earth magnet.

According to a heavy rare-earth grain boundary diffusion method, after a sintered magnet is manufactured, a heavy rare-earth compound powder is applied to the surface of the sintered magnet by various methods, such as spraying, gas phase deposition, coating or etc., sequentially to be heated at 700° C. or above in an argon atmosphere or under a vacuum such that a heavy rare-earth element applied to the magnet surface gradually diffuses to permeate inside the magnet, along the magnet grain boundary. When the heavy rare-earth element is permeated into the magnet, along the grain boundary by the diffusion reaction, the heavy rare-earth element is intensively distributed around the grain boundary. Since a magnetic defect to decrease coercivity in the intrinsic properties of a rare-earth sintered magnet is mostly distributed in the grain boundary, if the heavy rare-earth element is intensively distributed on the grain boundary, the heavy rare-earth element removes the magnetic defect, thereby increasing the coercivity.

In the aforementioned heavy rare-earth grain boundary diffusion method, the heavy rare-earth element needs to be sufficiently applied (twice times or more than the amount required for diffusion) for stable grain boundary diffusion during the process of applying the heavy rare-earth element. When the heavy rare-earth applied to the magnet surface during the grain boundary diffusion process is diffused and permeated into the magnet, since the diffusion needs to progress along the grain boundary which is narrow by nanometers (nm), it is not possible to maintain the uniform distribution of the heavy rare-earth element in the center of the magnet from the surface of the magnet. To be more specific, only a part of the heavy rare-earth element which has rapidly permeated through the magnet surface permeates into the magnet, along the narrow grain boundary at the beginning of diffusion. Since the speed of diffusion is gradually slow as the permeation into the magnet progresses more and more, when the distribution of the heavy rare-earth element of the magnet on which the grain diffusion is finished is measured, the concentration of the heavy rare-earth element is high on the surface of the magnet but almost no heavy rare-earth element is present inside the magnet, resulting in a lack of uniform distribution of the heavy rare-earth element composition.

### DISCLOSURE

### Technical Problem

Therefore, it is an object of the present invention to solve the above problems and to provide a method for manufacturing a rare-earth sintered magnet to reduce the amount of a heavy rare-earth element used and to improve the coercivity and thermostability of the magnet.

It is another object of the present invention to provide a method for manufacturing a rare-earth sintered magnet by simultaneously sintering and heat-treating a mixture of a heavy rare-earth compound including a heavy rare-earth hydride and a rare-earth magnet powder, so that a heavy rare-earth element is uniformly distributed to the surface and the grain boundary inside the magnet for stable magnetic performance.

### Technical Solution

In accordance with an embodiment of the present invention to achieve the above object, there is provided a method for manufacturing a rare-earth sintered magnet comprising the steps of: preparing a rare-earth magnet powder composed of R, Fe and B (wherein R is at least one element selected from rare-earth elements including Y and Sc, and M is at least one element selected from metals); mixing the rare-earth magnet powder with a heavy rare-earth compound including a heavy rare-earth hydride; molding the powder mixture as a compact in a magnetic field; and sintering and simultaneously performing heavy rare-earth diffusion.

The average particle diameter of the rare-earth magnet powder is 1˜10 μm.

In the mixing step, the content of the heavy rare-earth compound to the total content of the rare-earth magnet powder and heavy rare-earth compound is 1˜4 wt %.

The heavy rare-earth element of the heavy rare-earth compound is at least one element selected from Dy and Tb.

The heavy rare-earth compound further comprises a heavy rare-earth fluoride.

The weight of the heavy rare-earth hydride to the total weight of the heavy rare-earth compound is 50˜100 wt %.

The temperature for sintering and heavy rare-earth diffusion is 900˜1,100° C.

The heating rate at 700° C. or above upon the sintering and heavy rare-earth diffusion is 0.5˜15° C./min.

The rare-earth magnet powder further comprises a metal (M).

The method for manufacturing a rare-earth sintered magnet further comprises the step of performing a post heat treatment at 400˜600° C. after finishing the sintering and heavy rare-earth diffusion.

### Advantageous Effects

In the method for manufacturing a rare-earth sintered magnet according to an embodiment of the present invention as described above, after the heavy rare-earth compound including a heavy rare-earth hydride is mixed with the rare-earth magnet powder and the powder mixture is molded as a compact in a magnetic field, the compact is sintered and heat-treated simultaneously so that the heavy rare-earth element is uniformly distributed on the surface of the magnet and the grain boundary inside the magnet. Accordingly, the magnetic performance is stable and the coercivity and thermostability are improved by using a small amount of the heavy rare-earth element.

### MODE FOR INVENTION

The present invention will now be described more fully hereinafter with reference to the accompanying drawing(s), in which preferred embodiments of the invention are shown.

The terminology used herein is for the purpose of describing a particular embodiment(s) only and is not intended to be limiting of exemplary embodiments of the invention. It will be understood that the terms “comprises”, “comprising”, “includes” and/or “including” when used herein, specify the presence of stated features, integers, steps, operations, elements, and/or components, but do not preclude the presence or addition of one or more other features, integers, steps, operations, elements, components and/or groups thereof, unless the context clearly indicates otherwise.

A method for manufacturing a rare-earth sintered magnet according to an embodiment of the present invention comprises the steps of: preparing a rare-earth magnet powder including R, Fe and B as components mixing a heavy rare-earth compound including a heavy rare-earth hydride with the rare-earth magnet powder; molding the powder mixture as a compact in a magnetic field; and sintering and simultaneously performing heavy rare-earth diffusion. Selectively, the method may further comprise the step of performing a post heat treatment after the step of sintering and performing the heavy rare-earth diffusion.

Each step will be described in detail below:

(1) Step of Preparing a Rare-Earth Magnet Powder

In the rare-earth magnet powder including R, Fe and B as components, R may be at least one element selected from rare-earth elements including Y and Sc, and at least one element metal (M) may be selected as components. Metals (M) may be Al, Ga, Cu, Ti, W, Pt, Au, Cr, Ni, Co, Ta, Ag, etc. The rare-earth magnet powder is not limited, however, a Nb—Fe—B based sintered magnet powder may be used.

The rare-earth magnet powder composition is not limited, however, R is 27˜36 wt %, M is 0˜5 wt %, B is 0˜1 wt % and Fe is the remainder.

In one exemplary embodiment, an alloy of the composition is melted by a vacuum induction heating method and is prepared as an alloy ingot by a strip casting method. A hydrogenation treatment and dehydrogenation treatment [hydrogenation-disproportionation-desorption-recombination (HDDR)] process is performed to the alloy ingot in the range of room temperature to 600° C. to improve the crushability of the alloy ingot, and subsequently, the alloy ingot is prepared as a uniform and fine powder with a particle size of 1˜10 μm by using a pulverizing method, such as a jet mill, Attritor grinding mill, ball mill, vibration mill, etc. Preferably, the process of preparing the alloy ingot to the powder with the size of 1˜10 μm is performed in a nitrogen or inert gas atmosphere to prevent the deterioration of magnetic properties by contamination with oxygen.

(2) Step of Mixing the Heavy Rare-Earth Compound with the Rare-Earth Magnet Powder

The heavy rare-earth compound requisitely includes a heavy rare-earth hydride. The heavy rare-earth element may be at least one element selected from Dy and Tb. Ho may be additionally included. A heavy rare-earth fluoride may be further included. When the weight of the heavy rare-earth hydride to the total weight of the heavy rare-earth compound is within 50˜100 wt %, the properties are excellent, as shown in the examples to be later described.

When the heavy rare-earth compound powder is mixed with the rare-earth magnet powder, the content of the heavy rare-earth compound to the total content of the rare-earth magnet powder and heavy rare-earth compound is preferably 1˜4 wt %, as shown in the examples to be later described.

As one of the examples for mixing the heavy rare-earth compound with the rare-earth magnet powder, after a mixing ratio is measured, the mixture is uniformly mulled for 0.5˜5 hours by using a 3-D powder mixer. Preferably, the heavy rare-earth compound powder is prepared to be 10 nm˜10 μm in size, to uniformly mull the rare-earth powder and the heavy rare-earth compound powder. Preferably, the mixing process is performed in a nitrogen or inert gas atmosphere to prevent the deterioration of magnetic properties by contamination with oxygen.

(3) Step of Molding the Powder Mixture as a Compact in a Magnetic Field

A process of molding in a magnetic field is performed by using the powder mixture. As an example, after the mulled powder is packed into a molding die, the powder mixture is aligned by applying a DC magnetic field by electromagnets positioned at the right and left of the molding die and is simultaneously compression-molded as a compact by applying pressure of upper and lower punches. Preferably, the molding process is performed in a nitrogen or inert gas atmosphere to prevent the deterioration of magnetic properties by contamination with oxygen.

(4) Step of Sintering and Simultaneously Performing Heavy Rare-Earth Diffusion

When the molding process in a magnetic field is finished, the sintering process is performed simultaneously with the process of performing heavy rare-earth diffusion. In the step of sintering and simultaneously performing heavy rare-earth diffusion, the temperature for heat treatment and the heating rate are very important. As shown in the examples to be later described, preferably, the sintering and heavy rare-earth diffusion process is performed at 900˜1,100° C. and a heating rate at 700° C. or above is adjusted within 0.5˜15° C./min.

As one example, the compact obtained by the molding method in a magnetic field is loaded into a sintering furnace and sufficiently maintained at 400° C. or below, under a vacuum, so that any remaining impure organic matters are completely removed. Again, the compact is maintained for 1˜4 hours by increasing the temperature to the range of 900˜1,100° C., thereby simultaneously completing the sintering densification and the diffusion of the heavy rare-earth element. Preferably, the step of sintering and heavy rare-earth diffusion is performed under a vacuum or in an inert gas atmosphere, like argon. At 700° C. or above, a heating rate is 0.1˜10° C./min, preferably, 0.5˜15° C./min, to control the heavy rare-earth element to be uniformly diffused on the boundary of the crystal grains.

Selectively, a post heat treatment may be performed to stabilize the compact sintered and diffused with the heavy rare-earth element at 400˜900° C. for 1˜4 hours. Then, the compact is processed to a predetermined size, to be manufactured as the rare-earth magnet.

According to the rare-earth magnet manufactured by the aforementioned method, since the heavy rare-earth element is uniformly distributed on the surface of the magnet and the grain boundary inside the magnet, the magnetic performance is stable, the coercivity and thermostability of the magnet is improved using a small amount of the heavy rare-earth element, and the problems caused by the impurities are minimized by using the heavy rare-earth hydride.

The present invention will be more fully described with reference to the examples below:

### EXAMPLE 1

An alloy composed of 32 wt % R-66 wt % Fe-1 wt % M-1 wt % B (wherein R is a rare-earth element and M is a 3d metal) was melted by a vacuum induction heating method and was manufactured as an alloy ingot by using a strip casting method.

To improve the crushability of the alloy ingot, the alloy ingot was subjected to a process of absorbing hydrogen in a hydrogen atmosphere at room temperature and removing hydrogen under a vacuum at 600° C. [hydrogenation-disproportionation-desorption-recombination (HDDR)]. Subsequently, the alloy ingot was prepared as a uniform and fine powder with a particle size of 3.5 μm by a pulverizing method using the jet mill technique. The process of preparing the fine powder from the alloy ingot was performed in a nitrogen or inert gas atmosphere, to prevent the deterioration of magnetic properties by contamination with oxygen.

The pulverized rare-earth powder of 95˜99.5 wt % and the Dy-H or Tb-H heavy rare-earth compound powder of 5˜0.5 wt % were respectively measured and then uniformly mulled by the 3-D powder mixer for 2 hours. The heavy rare-earth compound powder with the particle size of 1 μm was used to be mulled.

The molding process in a magnetic field was performed by using the mulled powder mixture. After packing the mulled powder mixture into a molding die, the powder mixture was aligned by applying a DC magnetic field by electromagnets positioned at the right and left of the molding die and was simultaneously compression-molded as a compact by applying pressure of upper and lower punches.

The process of mulling the rare-earth powder and the heavy rare-earth compound powder and the process of molding the powder mixture in a magnetic field were performed in a nitrogen or inert gas atmosphere to prevent the deterioration of magnetic properties by contamination with oxygen.

The compact obtained by the molding process in a magnetic field was loaded in a sintering furnace and sufficiently maintained at 400° C. or below, under a vacuum, to completely remove any remaining impure organic matters, and further maintained for 2 hours by increasing a temperature to 1,020° C., to complete the sintering densification and the diffusion of a heavy rare-earth element. The sintering and heavy rare-earth diffusion process was performed under a vacuum and in an argon atmosphere. The heating rate was controlled as 1° C./min at a temperature of 700° C. or above so that the heavy rare-earth element was uniformly diffused at the boundary of crystal grains. The sintered compact was subjected to a heat treatment at around 500° C. for 2 hours and subsequently was processed to be 12.5*12.5*4 mm in size and its magnetic properties were measured.

A component analysis of the sample(s) according to the present invention and comparative sample(s) was conducted by using a wet analysis method. The magnetic properties were obtained by measuring each loop by applying a maximum magnetic field of 30 kOe by the B-H loop tracer. The results of analysis are shown in Table 1. Sample 1-1 was prepared without adding any heavy rare-earth powder during the powder mulling process. Samples 1-2 through 11-13 were prepared by mulling the Dy-H or Tb-H heavy rare-earth compound powder of 0.5˜5 wt % during the powder mulling process.

TABLE 1

| | | | | Heating | | | |
|---|---|---|---|---|---|---|---|
| | | | | rate of | | Residual | |
| | Type of | Heavy rare- | | sintering | Heavy | magnetic | |
| | heavy rare- | earth | Temperature for | and | rare-earth | flux | |
| | earth | compound | sintering and | diffusion | element | density, | Coercivity |
| Sample | compound | (wt %) a | diffusion (° C.) | (° C./min) | (wt %) | (kG) | (kOe) |
| 1-1 | x | x | 1020 | 1 | 0.00 | 13.50 | 14.5 |
| 1-2 | Dy—H | 0.5 | 1020 | 1 | 0.48 | 13.42 | 15.9 |
| 1-3 | Dy—H | 1 | 1020 | 1 | 0.96 | 13.33 | 17.4 |
| 1-4 | Dy—H | 2 | 1020 | 1 | 1.92 | 13.16 | 20.3 |
| 1-5 | Dy—H | 3 | 1020 | 1 | 2.88 | 12.99 | 23.1 |
| 1-6 | Dy—H | 4 | 1020 | 1 | 3.84 | 12.83 | 26.0 |
| 1-7 | Dy—H | 5 | 1020 | 1 | 4.80 | 12.11 | 27.5 |
| 1-8 | Tb—H | 0.5 | 1020 | 1 | 0.48 | 13.42 | 16.6 |
| 1-9 | Tb—H | 1 | 1020 | 1 | 0.95 | 13.34 | 18.8 |
| 1-10 | Tb—H | 2 | 1020 | 1 | 1.90 | 13.18 | 23.1 |
| 1-11 | Tb—H | 3 | 1020 | 1 | 2.85 | 13.02 | 27.3 |
| 1-12 | Tb—H | 4 | 1020 | 1 | 3.80 | 12.85 | 31.6 |
| 1-13 | Tb—H | 5 | 1020 | 1 | 3.75 | 12.15 | 33.8 |

a is the content of the heavy rare-earth compound to the total content of the rare-earth magnet powder and heavy rare-earth compound powder, which is the same in Tables 2 to 5 below.

As shown in Table 1, it is confirmed that a coercivity increase effect is slight when the mixing ratio of the heavy rare-earth compound is less than 1 wt % and a residual magnetic flux density rapidly increases when the mixing ratio of the heavy rare-earth compound excesses 4 wt %.

### EXAMPLE 2

Example 2 was carried out in the same manner as in Example 1, except that the heavy rare-earth compound powders used were different as shown in Table 2 below:

TABLE 2

| | | | | Heating | | |
|---|---|---|---|---|---|---|
| | | | | rate of | Residual | |
| | Type of | Heavy rare- | | sintering | magnetic | |
| | heavy rare- | earth | Temperature for | and | flux | |
| | earth | compound | sintering and | diffusion | density, | Coercivity |
| Sample | compound | (wt %) a | diffusion (° C.) | (° C./min) | (kG) | (kOe) |
| 1-1 | x | x | 1020 | 1 | 13.50 | 14.5 |
| 1-4 | Dy—H | 2 | 1020 | 1 | 13.16 | 20.3 |
| 2-1 | Dy—F | 2 | 1020 | 1 | 13.14 | 19.5 |
| 2-2 | Dy—O | 2 | 1020 | 1 | 13.20 | 16.1 |
| 1-10 | Tb—H | 2 | 1020 | 1 | 13.18 | 23.1 |
| 2-3 | Tb—F | 2 | 1020 | 1 | 13.17 | 22.0 |
| 2-4 | Tb—O | 2 | 1020 | 1 | 13.21 | 17.5 |

As shown in Table 2, it is confirmed that the heavy rare-earth hydride has an excellent effect of increasing coercivity compared to the heavy rare-earth fluoride or heavy rare-earth oxide.

### EXAMPLE 3

Example 3 was carried out in the same manner as in Example 1, except that the heavy rare-earth compound powder mixtures were used as shown in Table 3 below:

TABLE 3

| | | | Mixing | | Heating | Residual | |
|---|---|---|---|---|---|---|---|
| | Type of | Heavy rare- | rate of | Temperature | rate of | magnetic | |
| | heavy rare- | earth | heavy | for sintering | sintering | flux | |
| | earth | compound | rare-earth | and diffusion | and diffusion | density, | Coercivity |
| Sample | compound | (wt %) a | powder (wt) | (° C.) | (° C./min) | (kG) | (kOe) |
| 1-1 | x | x | x | 1020 | 1 | 13.50 | 14.5 |
| 3-1 | Dy—H:Dy—F | 2 | 25:75 | 1020 | 1 | 13.14 | 19.7 |
| 3-2 | Dy—H:Dy—F | 2 | 50:50 | 1020 | 1 | 13.14 | 19.9 |
| 3-3 | Dy—H:Dy—F | 2 | 75:25 | 1020 | 1 | 13.15 | 21.1 |
| 1-4 | Dy—H | 2 | 100 | 1020 | 1 | 13.16 | 20.3 |
| 3-4 | Tb—H:Tb—F | 2 | 27:75 | 1020 | 1 | 13.17 | 22.4 |
| 3-5 | Tb—H:Tb—F | 2 | 50:50 | 1020 | 1 | 13.17 | 22.7 |
| 3-6 | Tb—H:Tb—F | 2 | 75:25 | 1020 | 1 | 13.17 | 22.9 |
| 1-10 | Tb—H | 2 | 100 | 1020 | 1 | 13.18 | 23.1 |

As shown in Table 3, it is confirmed that when the weight of heavy rare-earth hydride to the total weight of the heavy rare-earth compound was 50˜100 wt %, the coercivity was excellent.

### EXAMPLE 4

Example 4 was carried out in the same manner as in Example 1, except that the temperature for sintering and diffusion varied as shown in Table 4 below:

TABLE 4

| | | | | Heating | | |
|---|---|---|---|---|---|---|
| | | | | rate of | Residual | |
| | Type of | Heavy rare- | | sintering | magnetic | |
| | heavy rare- | earth | Temperature for | and | flux | |
| | earth | compound | sintering and | diffusion | density, | Coercivity |
| Sample | compound | (wt %) a | diffusion (° C.) | (° C./min) | (kG) | (kOe) |
| 1-1 | x | x | 1020 | 1 | 13.50 | 14.5 |
| 4-1 | Dy—H | 2 | 880 | 1 | 10.25 | 3.5 |
| 4-2 | Dy—H | 2 | 900 | 1 | 11.88 | 11.3 |
| 4-3 | Dy—H | 2 | 980 | 1 | 13.00 | 19.5 |
| 4-4 | Dy—H | 2 | 1000 | 1 | 13.11 | 20.0 |
| 1-4 | Dy—H | 2 | 1020 | 1 | 13.16 | 20.3 |
| 4-5 | Dy—H | 2 | 1040 | 1 | 13.17 | 20.1 |
| 4-6 | Dy—H | 2 | 1060 | 1 | 13.16 | 20.0 |
| 4-7 | Dy—H | 2 | 1100 | 1 | 13.14 | 18.6 |
| 4-8 | Tb—H | 2 | 880 | 1 | 10.55 | 5.7 |
| 4-9 | Tb—H | 2 | 900 | 1 | 11.93 | 12.8 |
| 4-10 | Tb—H | 2 | 980 | 1 | 13.05 | 22.5 |
| 4-11 | Tb—H | 2 | 1000 | 1 | 13.12 | 22.9 |
| 1-9 | Tb—H | 2 | 1020 | 1 | 13.18 | 23.1 |
| 4-12 | Tb—H | 2 | 1040 | 1 | 13.19 | 23.0 |
| 4-13 | Tb—H | 2 | 1060 | 1 | 13.18 | 22.8 |
| 4-14 | Tb—H | 2 | 1100 | 1 | 13.16 | 21.4 |

As shown in Table 4, it is confirmed that when the temperature for sintering and heavy rare-earth diffusion was 900˜1,100° C., the coercivity was higher.

### EXAMPLE 5

Example 5 was carried out in the same manner as in Example 1, except that the heating rate at a temperature of 700° C. or above varied as shown in Table 5 below:

TABLE 5

| | | | | Heating | | |
|---|---|---|---|---|---|---|
| | | | | rate of | Residual | |
| | Type of | Heavy rare- | | sintering | magnetic | |
| | heavy rare- | earth | Temperature for | and | flux | |
| | earth | compound | sintering and | diffusion | density, | Coercivity |
| Sample | compound | (wt %) a | diffusion (° C.) | (° C./min) | (kG) | (kOe) |
| 1-1 | x | x | 1020 | 1 | 13.50 | 14.5 |
| 5-1 | Dy—H | 2 | 1020 | 0.1 | 13.19 | 20.3 |
| 5-2 | Dy—H | 2 | 1020 | 0.5 | 13.19 | 20.3 |
| 1-4 | Dy—H | 2 | 1020 | 1 | 13.16 | 20.3 |
| 5-3 | Dy—H | 2 | 1020 | 2 | 13.15 | 20.1 |
| 5-4 | Dy—H | 2 | 1020 | 5 | 13.15 | 20.1 |
| 5-5 | Dy—H | 2 | 1020 | 10 | 13.14 | 19.8 |
| 5-6 | Dy—H | 2 | 1020 | 15 | 13.11 | 19.2 |
| 5-7 | Dy—H | 2 | 1020 | 20 | 13.06 | 18.7 |
| 5-8 | Tb—H | 2 | 1020 | 0.1 | 13.19 | 23.1 |
| 5-9 | Tb—H | 2 | 1020 | 0.5 | 13.19 | 23.1 |
| 1-9 | Tb—H | 2 | 1020 | 1 | 13.18 | 23.1 |
| 5-10 | Tb—H | 2 | 1020 | 2 | 13.18 | 22.8 |
| 5-11 | Tb—H | 2 | 1020 | 5 | 13.16 | 22.7 |
| 5-12 | Tb—H | 2 | 1020 | 10 | 13.15 | 22.5 |
| 5-13 | Tb—H | 2 | 1020 | 15 | 13.11 | 22.1 |
| 5-14 | Tb—H | 2 | 1020 | 20 | 13.08 | 21.4 |

As shown in Table 5, it is confirmed that when the coercivity has excellent properties within 0.1˜15° C./min of a heating rate and preferably, 0.5˜15° C./min taking consideration of mass production.

While the present invention has been particularly shown and described with reference to examples thereof, it will be understood by those of ordinary skill in the art that various modifications and alternative arrangements in form and details may be made therein without departing from the spirit and scope of the present invention as defined by the following claims. The scope of the claims, therefore, should be accorded the broadest interpretation so as to encompass all such modifications and similar arrangements.

1. A method for manufacturing a rare-earth sintered magnet, the method comprising the steps of:
preparing a rare-earth magnet powder composed of R, Fe and B, wherein R is at least one element selected from rare-earth elements including Y and Sc;
mixing the rare-earth magnet powder with a heavy rare-earth compound including a heavy rare-earth hydride;
molding the powder mixture as a compact in a magnetic field; and
sintering and simultaneously performing heavy rare-earth diffusion.

2. The method of claim 1, wherein an average particle diameter of the rare-earth magnet powder is 1˜10 μm.

3. The method method of claim 1, wherein, in the mixing step, the content of the heavy rare-earth compound to the total content of the rare-earth magnet powder and heavy rare-earth compound is 1˜4 wt %.

4. The method method of claim 1, wherein the heavy rare-earth element of the heavy rare-earth compound is at least one element selected from Dy and Tb.

5. The method f method of claim 1, wherein the heavy rare-earth compound further comprises a heavy rare-earth fluoride.

6. The method method of claim 5, wherein the weight of the heavy rare-earth hydride to the total weight of the heavy rare-earth compound is 50˜100 wt %.

7. The method method of claim 1, wherein the temperature for sintering and heavy rare-earth diffusion is 900˜1,100° C.

8. The method method of claim 1, wherein the heating rate at 700° C. or above upon the sintering and heavy rare-earth diffusion is 0.5˜15° C./min.

9. The method method of claim 1, wherein the rare-earth magnet powder further comprises another metal (M).

10. The method method of claim 1, further comprising the step of performing a post heat treatment at 400˜600° C. after finishing the sintering and heavy rare-earth diffusion.
